(19) United States
(12) Patent Application Publication
(10) Pub. No.: US 2007/0198718 A1
(43) Pub. Date: Aug. 23, 2007

(54) System and method for providing virtual access, storage and management services for IP devices via digital subscriber lines

(75) Inventors: Raghvendra G. Savoor, Walnut Creek, CA (US); Rene Wever, Danville, CA (US); Richard E. Burke JR., Dublin, CA (US)

Correspondence Address: BRINKS HOFER GILSON & LIONE, P.O. BOX 10395, CHICAGO, IL, 60610, US

(73) Assignee: SBC Knowledge Ventures, L.P.

(21) Appl. No.: 11/341,114

(22) Filed: Jan. 27, 2006

(51) Int. Cl. G06F 15/173

(52) U.S. Cl. 709/226

(57) ABSTRACT

A method and system of providing virtual access, storage and management services to IP-enabled computing devices of a user includes establishing a first communication link between a first computing device and an online service provider that provides the offsite data storage, accessing all data residing in the first computing device over the first communication link, and storing a complete system image at the offsite data storage service. The method further includes establishing a second communication link between an authorized second computing device and the online service provider, and providing to the second computing device via the second communication link access to at least part of the complete system image of the first computing device stored by the online service provider.

### FIELD

The present disclosure relates, in general, to storage area network-based services and, in particular, to a system and a method for providing virtual access, storage and management services for Internet Protocol (IP) devices via Digital Subscriber lines (DSL).

### BACKGROUND

Consumer/business computer users who want to access applications and data files from a foreign computer (i.e. remotely located from the consumer/business computer) typically use a system environment of the foreign computer, the foreign system environment including, for example, desktop settings, Internet browser settings, applications loaded on the foreign computer, Internet shortcut list, and font style preferences. Generally, users need to provide program set-up information, such as Microsoft Outlook initial settings, for example, prior to using an application (presuming the application is loaded on the foreign computer).

Consumer/business computer users often cannot remotely access their home/business applications, data, and/or multi-media files without experiencing system delays associated with the files traversing a relatively low-bandwidth access loop to their residence. Consumer/business computer users also need to purchase and provide physical space for additional home/business computer storage capability as their storage needs grow. Storage needs are expected to grow dramatically as video-related home/business applications grow. Consumer/business computer users who temporarily need to access large applications and/or files typically need to purchase and find physical space for additional home/business computer storage capability that may go to waste much of the time.

Consumer/business computer users who want to scan and clean their home/business applications, data, and/or IP device files may first need to ensure they are all downloaded onto their home/business computer. They typically also need to remember to perform the functions periodically, and to take the time to run the scanning and cleaning operations. Alternatively, online virus scanning and cleaning services may need to be scheduled and manually managed to avoid interference with home/business computer use for other applications. A home/business computer may be inaccessible for other applications while this time-consuming process takes place. As storage demands and/or needs continue to grow, the time-consumption for virus scanning and cleaning is likely to continue to grow.

Consumer/business computer users who want to back-up files stored on their home/business IP devices generally need to do so by first loading them onto their home/business computer, and then performing a back-up process. Again, this process may involve a significant amount of time.

Accordingly, there is a need for addressing the problems noted above and others previously experienced.

### BRIEF DESCRIPTION OF THE DRAWINGS

FIG. 1 is a block diagram illustrating a telecommunications system;

FIG. 2 is a block diagram illustrating examples of components of an IP service provider;

FIG. 3 is a flow chart illustrating a method for accessing stored data and providing virtual access to the stored data;

FIG. 4 is a flow chart illustrating a method for scanning for computer viruses; and

FIG. 5 is a block diagram illustrating an embodiment of a general computer system.

### DETAILED DESCRIPTION OF THE DRAWINGS

According to one aspect, a method and a system for establishing virtual access, storage and management services for Internet Protocol (IP) devices via Digital Subscriber lines (DSL) is provided. The provided system and method are advantageous in that they enable a subscriber or customer to store a complete system image, also referred to as a mirror image, of one or more IP enabled devices at a customer premise via a storage area network (SAN). The customer may then access some or all of the computer image with a remote or foreign IP device. In another aspect, the method and the system are advantageous in that they enable network-based software virus and spyware servicing of the system image via the SAN. In still another aspect, the method and the system are advantageous in that they enable post-servicing downloads on a subscriber-aware basis.

In another aspect, online data storage system accessible to a user for providing virtual access to a computing device is described. The system may include a data storage unit having a complete system image of a first computing device remotely located from the data storage unit. The storage system may include a communication module configured to automatically and periodically establish communication between the data storage unit and the first computing device, as well as a processor configured to automatically update software or data contained in the complete system image to generate an updated complete system image and to subsequently update the first computing device from the updated complete system image. The data storage system may also be configured to be subscriber aware so that an availability of the first computing device, whether through detecting an amount of communication bandwidth being used by/remaining to the first computing device, the number or types of applications running on the first computing device, or a combination of these or other criteria, may be assessed.

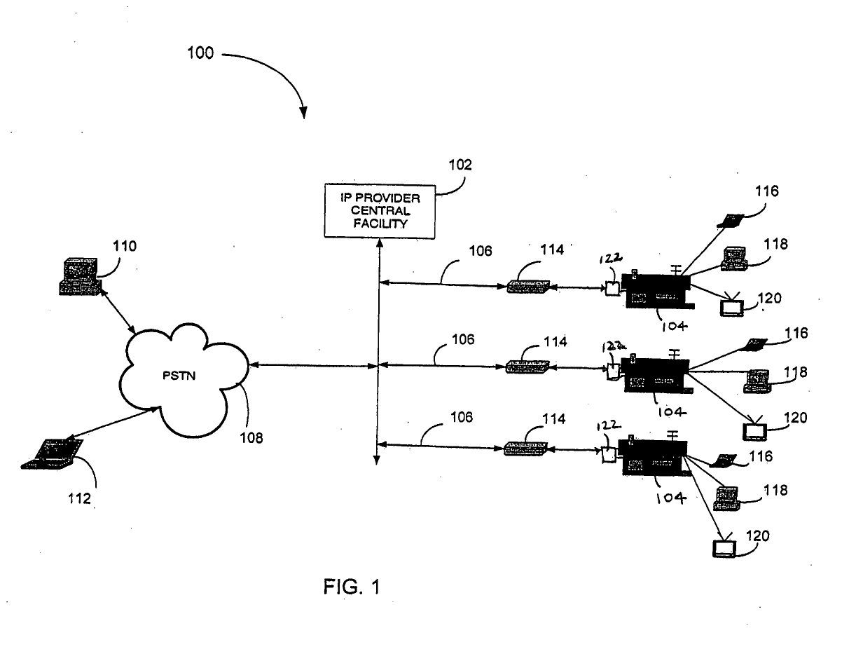

Referring to FIG. 1, one configuration of a suitable telecommunications system 100 is shown. The telecommunications system 100 includes an Internet Service Provider (ISP) (or Internet Access Provider (IAP)) central facility 102 in communication with at least one customer 104 via broadband digital subscriber lines (DSL) 106, and with a Public Switched Telephone network (PSTN) 108. In turn, the PSTN 108 is coupled to remote personal computing devices, for example desktop device 110 and portable device 112. The remote desktop and portable devices 110 and 112 may be referred to as foreign computing devices or computers. The PSTN 108 may be any public carrier and may also include other communication networks.

As shown in FIG. 1, the Internet customer or user 104 may be connected to the ISP central facility 102 via, for example, a standard personal computer 118, a portable computer 116, and an Internet connected television 120. The personal and portable computers 118 and 116 each typically include a main processor unit, a display, a keyboard, and a mouse. The main processing units typically include a floppy disk slot or drive that reads floppy diskettes and/or a compact disk (CD) drive that reads and may also write on CDs. Generally, the main processing units perform tasks for the user 104 under software control, and display the results of the tasks on the displays (and optionally printers can be connected to the main processing units in order to print out the results). New software can be loaded onto customer computers 116 and 118 by storing the software on floppy diskettes or CDs and inserting the floppy diskettes or CDs into their respective drives so that they can be read by the main processor units. The user 104 typically operates a keyboard and/or a mouse to interact with the software tasks performed by computers 116 and 118.

In addition to personal computers, IP-capable computing devices on the user's local area network (LAN) may include, but are not limited to, personal digital assistants (PDA's), voice-over-IP (VOIP) phones, portable music recorders/players, cameras, multi-media devices such as: audio and video recording and/or playback equipment, digitally-based storage libraries (e.g., CD's, DVD's, Hard-drive based), television sets, home/business appliances, heating/ventilation/air conditioning equipment, security locks, among others.

For the sake of simplicity, only the personal computer 118 will be referred to in the following discussions used as the access source or point to the ISP central facility 102 from the user's residence. The personal computer 118 as described above may be a self-contained, stand-alone unit that is capable of performing a wide variety of processing tasks without having to be connected to any other computer equipment. For example, the user 104 can run word processing programs, and perform a wide variety of additional software tasks such as, for example, financial calculations using a spreadsheet program, video games, check book management, graphics generation program, among others. Although, the personal computer 118 is used, any other applicable computing device may also be used.

With this FIG. 1 arrangement, the ISP central facility 102 is coupled to the personal computer 118 via broadband DSL lines 106. These digital subscriber lines (DSL) 106 include a representative digital subscriber line access multiplexer (DSLAM) 114. Additionally, the coupling of the personal computer 118 to the ISP central facility 102 may include a DSL modem (not shown), and a wireless access point (WAP) interface (not shown). The DSL lines 106 may include a DSL or telephone company trunk termination.

Generally, the DSLAM 114 is equipment that enables the DSL service to the user's residence. The DSLAM 114 may take connections from many users 104 and aggregate them onto a single, high-capacity connection to the Internet. The DSLAM 114 is generally flexible and able to support multiple types of DSL in a single central office, and different varieties of protocol and modulation, such as carrier-less amplitude and phase (CAP) and discrete multi-tone (DMT), for example, in the same type of DSL. In addition, the DSLAM 114 may provide additional functions including routing or dynamic IP address assignment for the customers 104. Moreover, The DSLAM 114 may provide Internet access service to the customers 104 through asymmetric DSL (ADSL), symmetric DSL (SDSL), or rate-adaptive DSL (RADSL) lines.

At the customer's local area network (LAN), a DSL gateway 122 may be installed. This gateway needs to be compliant with customer premises equipment (CPE) wide area network (WAN) management protocols. One example of such DSL gateway 122 is the DSL Forum TR-069 gateway. A technical report on the DSL Forum TR-069 issued on May 2004 was produced by DSL Home Technical Working Group. The DSL gateway 122 may ensure that DSL CPE's can be relatively easily and securely configured, activated and managed from a console at the ISP central facility 102, for example. The ISP may update software and firmware, monitor the status and performance of the user's connection and perform diagnostic tests all from a console in the ISP premises. This arrangement allows the DSL service provider an efficient and cost effective deployment of services to the user 104 while maintaining user satisfaction. Hence, the user 104 may need either a software agent or firmware functionality (e.g., Jini-enabled) on each of the IP devices 116, 118, and 120 on the LAN that can make use of the services. The Jini network technology provides an open software architecture that enables Java dynamic networking for building distributed systems that are highly adaptive to change. Currently, the addition of computing devices to a computer or network may need installation and boot-up, but a computing device that incorporates the Jini technology can announce itself to the network, provide some details about its capabilities, and immediately become accessible to other computing devices on the network.

If needed, additional software in the TR-069-compliant gateway or another connected computer or server (not shown) may help support the interface from the IP devices 116, 118, and 120 to the provider's storage area network (SAN) (not shown), located at the ISP central facility 102 for data input/output control of IP devices 116, 118, and 120. Software application(s) may need to support ISP administration, user administration, user connection from home, and remote user connection. Software agents may be provided for the foreign computers 110 and 112, the user 104 Customer away from home when Internet or Web connected, as well as for the ISP Administrator.

The TR-069-compliant gateway may support the following ISP management services:

a. user policy services (such as user rights and privileges);

b. user provisioning services (such as new services and service changes);

c. user accounting services;

d. service level surveillance and performance management; and

e. trouble-shooting/repair services.

These enumerated services would be subscribed to by premise (user's home or business), by Internet Protocol (IP) device, and/or by user. Moreover, services associated with the service-provider accessing IP devices 116, 118, and 120 on the user's LAN may be done in a secure environment and on a not-to-interfere basis with the use of these IP devices 116, 118, and 120. The latter functionality may be implemented by taking advantage of the DSL gateway 122 being aware of the subscriber's activities and imparting that information to the service provider's network.

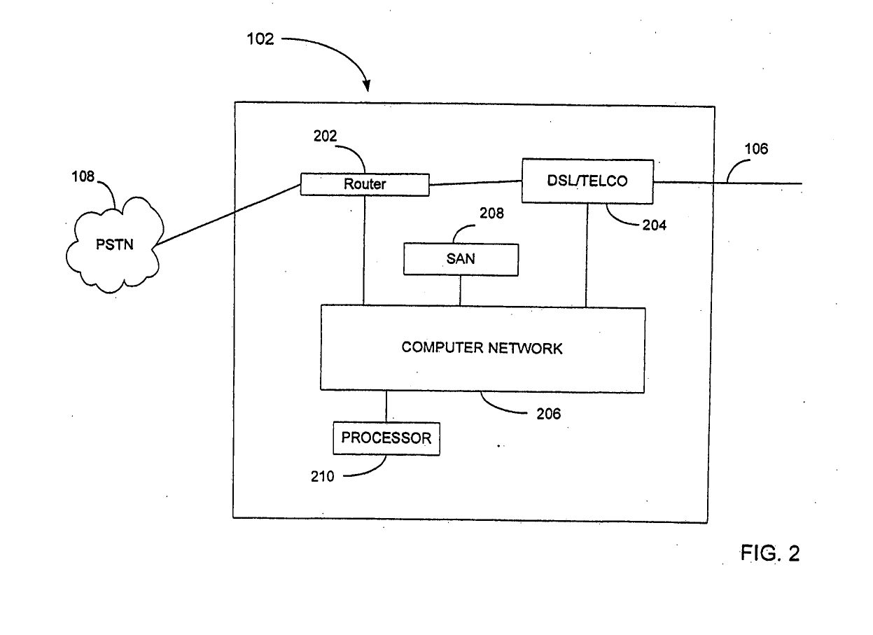

Referring now to FIG. 2, an example of a suitable ISP central facility 102 includes an internal router 202, a DSL/telephone company (DSL/TELCO) trunk aggregation unit 204, a computer network 206 including a processor 210, and a storage area network (SAN) 208. The router 202 is a device that forwards data packets along networks. Routers are typically located at gateways, where two or more networks connect. Routers use headers and forwarding tables to determine the best path for forwarding packets, and use protocols such as Internet control message protocol (ICMP) to communicate with each other and configure the best route between any two hosts.

The SAN 208 is typically a high-speed network that interconnects different kinds of data storage devices with associated data servers on behalf of a larger network. The SAN 208 may be clustered in close proximity to other computing resources but may also extend to remote locations for backup and archival storage, using WAN technology. The SAN 208 has generally an architecture configured to meet requirements of networking data storage, and is a network based replacement for direct attached storage (DAS) allowing storage devices (DASD) to be shared without having to rely on accessing through a server and for reducing the load on the LAN. The SAN 208 may include a management layer, which organizes connections, storage elements, and computer systems so that data transfer is substantially secure and robust.

The SAN 208 may use existing communication technology such as Optical Fibre Enterprise Systems Connection (ESCON), Fiber Channel, newer technology Internet Small System Computer Interface (ISCSI)/IPSAN and mixed heterogeneous protocol. The SAN 208 may provide the following services or support:

a. Full and incremental backup of consumer devices,

b. Auto discovers all IP devices on the LAN,

c. OS settings, environment settings, drivers, registered keys,

d. Application activity awareness to avoid overlapping backup and restore activity,

e. Security scan of images, reporting recommendations,

f. Support for full/incremental restore and rollback,

g. Virtual desktop service to access images from anywhere, and

h. Virtual Additional Disk Capacity (VADC) on demand.

Generally, an internal hard disk or disks (not shown) within the main processor unit of the personal computer 118 is used to store all of the data generated as well as all of the software to be executed by the personal computer 118. However, the internal hard disk may run out of space to store additional data or programs, or may fail and lose all of the data it previously stored. The user 104 can “back up” the data stored on the internal hard drive using floppy diskettes, and CDs. This diskette or CD back-up process may be a time-prohibitive and tedious process and the user 104 may at times forget to do it.

The SAN 208 may provide one or more “virtual” hard drives to back up the personal computer 118. Generally, a virtual device is an arrangement that simulates, emulates, and duplicates a locally-attached, physical device. For example, the virtual hard drive may be an arrangement that may combine remote hardware and/or software that “looks like” a physical drive. Moreover, the SAN 208 may create this virtual hard drive from internal and external memory resources and disk resources, and/or software. Thus, the SAN 208 may be programmed or configured to perform full and incremental backups and restorations of the personal computer 118. These backup services or processes may be performed on an automatically-scheduled basis in the secure environment of the SAN 208, and may not need any time or effort on the part of the user 104. Alternately, these backup processes may be event or object triggered processes so as to minimize unnecessary or redundant backups of unchanged and previously backed up data or files. Further, an application or user activity awareness service may be provided by the SAN 208 in order to avoid overlapping it with any backup and restore activity. Moreover, because of the subscriber-aware DSL-network knowledge, enabled by the gateway 122, the backup process may be programmed to be performed at times that do not create accessibility or activity problems for the IP user 104. That is, the backup process may be programmed to execute only when DSL bandwidth is available and/or time-sensitive or essential applications are not running.

Typically, when the user 104 wants to back-up files stored on the other IP devices 116 and 120, these files need to be first loaded onto the personal computer 118 before performing the back-up process. However, because of the SAN 208 ability to recognize or determine all connected (auto discover) IP devices on the user's LAN, such user back up activity is no longer needed as the SAN 208 backup service or process is also applicable to these other IP devices 116 and 120. Thus, the virtual hard drives of the SAN 208 enable the IP user access to virtual copies or images of part or all information and files stored on the personal computer 118 and on the other IP devices 116 and 120. In addition to backing up the stored information and files, the SAN 208 may include a fuller image of the computing environment of the personal computer 118, which includes the operating system (OS) and its settings, registration keys, cookies, passwords, device drivers, application programs, and data files, among others.

Computer users cannot generally remotely access their home/business applications, data, and/or multi-media files without experiencing system delays associated with the files traversing a relatively low-bandwidth access loop to their residence. Moreover, when the user 104 wants to access home/business applications and data files while located at a foreign computer 110 and 112, the user 104 uses the system environment of the foreign computer 110 and 112, such as foreign desktop, foreign Internet browser settings, applications loaded on the foreign computers, foreign internet shortcut list, and foreign font style preferences, among others. The user 104 typically needs to program set-up information, such as Microsoft Outlook initial settings, for example, prior to using an application presuming the application is loaded on the foreign computers.

Using the subscribed ISP services provided with the SAN 208, the user 104 who wants to access applications and data files from foreign computers 110 and 112 via the PSTN 108 may be able to access a thin client, for example a JAVA client, and operate at the foreign computer using his normal home environment. Alternatively, the user may download a thin client onto the foreign computers 110 and 112 and then conduct computing using his normal home computing environment. The term thin client typically refers to an application program or software that communicates with an application server and relies for a bulk of its data processing on separate software, which typically runs at the application server.

One example of such software-only thin client is PXES Universal Linux Thin Client.

With the JAVA client or the downloaded thin client on the foreign computers 110 and 112, the user 104 may access images of the user's resources on the SAN 208 as if those resources were locally attached to the personal computer 118. That is, communications software and device driver programs executing on the foreign computers 110 and 112 cooperating with communications and other software executing on the SAN 208 enable the user to access the backed up information and files. Thus, the JAVA client or downloaded thin client in conjunction with the SAN 208 provide the user 104 with a virtual desktop to access stored information, and files from any IP connected remote location.

In order for the foreign computers 110 and 112 to access images of the user's resources stored on the SAN 208, a corresponding communication link may need to be established via an access authorization or validation procedure performed by the SAN 208. This access authorization by SAN 208 may be accomplished via typical login names or user names and passwords, IP addresses, and pass codes, among others. The pass code may comprise a fixed personal identification number (PIN) and a time variable security token password.

This remote access from foreign computers 110 and 112 may include controlling and accessing the home IP devices 116, 118, and 120, and associated files, such as watching content from the home personal video recorder, watching home-based IPTV, listening to music on a stored-audio device, adjusting the home thermostat temperature, watching video from a surveillance camera, and manipulating files associated with a printer/copier/fax, among others. Moreover, the user 104 may access the home applications, data, and/or multi-media files from the SAN 208 without system delays associated with relatively low-bandwidth access loop to their residence.

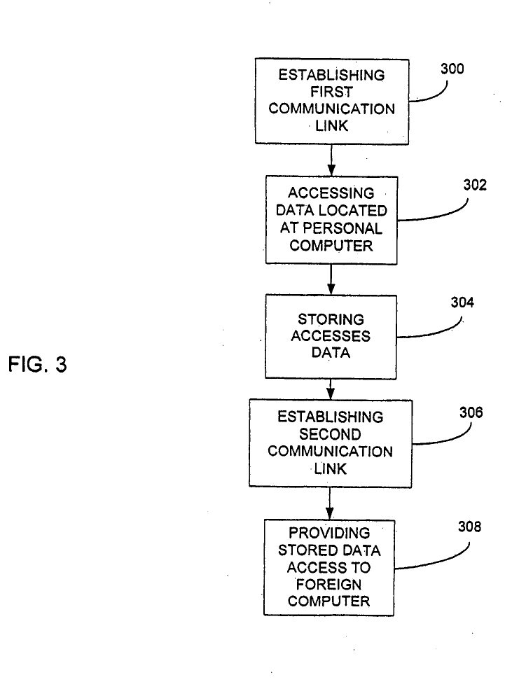

Referring to FIG. 3, a flow chart illustrates a method for providing virtual access, storage and management services to computing devices of a user connected to an offsite data storage service via communication links. The method establishes a first communication link on the broadband digital subscriber lines (DSL) 106 between the personal computer 118 and the SAN 208, at step 300. At step 302, the proposed method triggers the SAN 208 to access data located on the first computing device over the first communication link for either full or incremental data back ups, and store the accessed data at the SAN 208, at step 304. In an initial communication or communications between the user and the SAN, a complete system image may be made of the user device, in this example the user's personal computer 118, at the SAN. This complete system image, sometimes referred to as a mirror, at the SAN may be a bit-for-bit copy of all data, settings, parameters and so on of the complete environment of the user device. At step 306, the method establishes a second communication link between the foreign computing device 112, for example, and the SAN 208 to enable the foreign computing device 112 to access at least part of the system image stored, at step 308.

Generally, the user 104 may want to update outdated software via new updates or new software versions. The new updates or versions of software may be obtained via new CDs or downloads, and require the user to go through the time-consuming, and sometimes confusing, process of loading the software onto the main processor unit of the personal computer 118. Typically, this updating is performed regularly or routinely for certain software in order for that software to remain current and effective. An example of such software includes virus detection software that minimizes risks of catching viruses introduced when loading new software, opening foreign documents, and incoming emails, among others.

Further, when the user 104 wants to scan and clean their home applications, data, and/or IP device files, the user 104 may first ensure that the updates, virus definitions or other necessary components are all downloaded onto the personal computer 118. The user 104 needs also to remember to perform these functions periodically, and needs to take the time to run the scanning and cleaning operations. Alternatively, online virus scanning and cleaning services need be scheduled and manually managed to avoid interference with the use of the personal computer 118 for other applications. The personal computer 118 may be inaccessible, or provide decreased processor performance, for other applications while this time-consuming process takes place. As storage requirements continue to grow, the time-consumption for virus scanning and cleaning is likely to continue to grow. Accordingly, via the subscribed services described herein, the user 104 may get his home applications, data, and/or IP device application and data files scanned and cleaned by the ISP, using the secure location of the SAN 208. As long as the IP devices 116 and 120, with memory storage, are connected to the user's LAN, these scanning and cleaning services may be performed on an automatically-scheduled basis, and may not require any time or effort on the part of the user. Moreover, these scanning and cleaning services may be performed when the first computing device activities are not impacted.

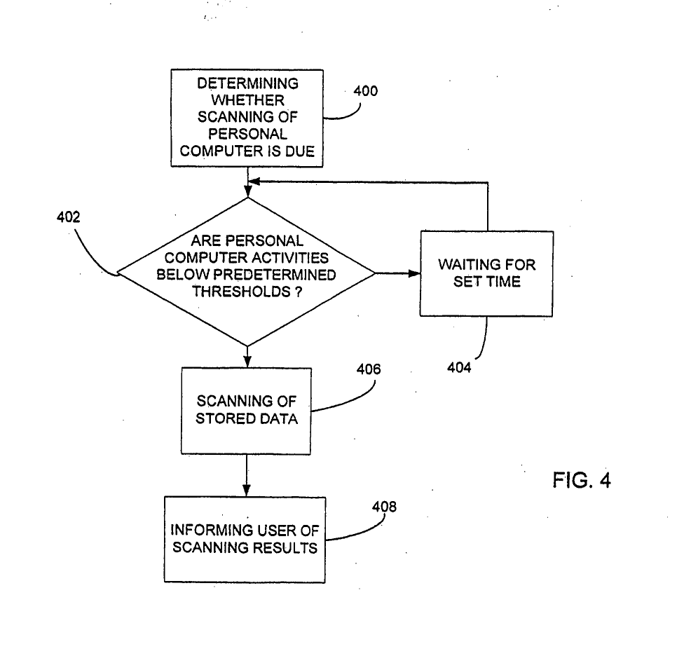

Referring to FIG. 4, a flow chart illustrates a method for scanning the personal computer 118 for computer viruses from the SAN 208. The ISP 102 determines whether the data located at the personal computer 108 is due for a scanning based on a predetermined elapse time since the last scanning, on recent file or program downloads, or email openings, at step 400. The DSL gateway 122, as part of the TR-069 protocol, may transmit user Internet activity information to the ISP 102 so that the processor 210 charged with monitoring the user 104 will be able to determine if a user device is active or monitor a threshold of activity. This activity level may be in the form of the personal computer's state of activity, for example whether the computer is engaged in email activity versus web-browsing, where email usage would not prevent the ISP from initiating updates or back-ups, while web-browsing would delay ISP intervention. The threshold of user activity may even include the number of data packets downloaded over a given, recent, time period. In this manner, the ISP may be able to initiate activity with the user device, even though web-browsing activity is detected, if the data packet rate is less than X packets over the past Y minutes, where X and Y may be user designated parameters stored at the ISP.

In one example, if the ISP 102 determines that there is any activity at the user, it may delay exchanging information between the SAN and the user. Alternatively, the processor may be configured to allow the SAN to exchange data with the user if the detected activity is below some other predetermined threshold, for example if the activity detected is the use of less than half the user's available DSL bandwidth. The DSL gateway 122 may automatically provide Internet activity information to the SAN on a periodic basis or in response to the detection of Internet activity at the user premises 104, or in response to a SAN-generated query. The ISP 102 further checks whether current activities of the personal computer 118 are below the predetermined activity threshold, at step 402. In the affirmative, the method triggers the scanning of the user's files and programs residing on the personal computer 118, at step 406. Otherwise, the processor 210 initiates a predetermined waiting time period before rechecking on the activity status of the personal computer 118, at step 404. Once the scanning has been completed, the ISP 102 informs the user whether the scanning of the user's files has discovered any viruses, at step 408.

In one implementation of the method illustrated in FIG. 4, the scanning and/or cleaning of the user data may take place on the complete system image maintained at the SAN, with the updates and results then copied to the appropriate user device when the user is not otherwise accessing the Internet. In another implementation, the ISP 102 may first acquire the necessary updates and data and store them on the SAN 208 to keep the anti-virus (or other) application current, and then download these updates to the appropriate user device for execution at the user device when it detects that the user 104 is not accessing the internet. In this second example, the actual execution of the application, in this instance an anti-virus application, is performed at the personal computer 118 and the results copied to the system image at the SAN 208. The decision as to whether the scanning will take place on the system image or on the personal computer is a user configurable option that may be stored in the SAN and updated by the user.

The trigger for running the application, whether an anti-virus, anti-spyware or other application, may be the passage of time as set by the user and monitored by the ISP 102, the receipt of new application updates or data relevant to the application at the SAN, a manual request by the user, or any other user configurable event. With respect to handling updates, whether for a freely available program upgrade for an anti-virus program, an operating system component such as from Microsoft WIDOWS, firmware for a device attached to the user's IP network, or other downloadable information, the ISP or SAN may be configured to either automatically execute the update, or query the user 104 for permission to download and execute the update. For updates having a monetary cost, the ISP or SAN may be programmed to query the user 104 for permission to pay and download the proposed update, or be programmed in advance with authorization to automatically perform certain for-pay updates for predetermined programs at predetermined intervals.

Users 104 often want to run a variety of different software; however the personal computer 118 can only run software that has been loaded onto it. In order to perform a new function or task, the user 104 may need to obtain floppy diskettes or CDs containing a new program from a software store or may need to download the new program from a vendor or a service providing it, then load the new software onto the internal hard drive of the personal computer 118. If the new software is a big program, this loading process can take a lot of time. In addition, the loading process may be confusing to the user 104. Moreover, there may be no convenient way to “try out” or temporarily rent or use software with the personal computer 118.

In order to remedy these problems with large applications and/or files, the user 104 may purchase and find physical space for additional computer storage capability. With the subscribed services, however, the user 104 may use the virtual hard drive at the SAN 208 for temporary use of large applications and/or files and avoid the need to buy additional local hard drive capability, or need to find additional physical space for additional hard drive capability. That is, the SAN 208 may be configured as a primary storage for these applications. Alternatively, the SAN may be configured with a temporary duplicate of the user's system image for use as a beta testing site for trying out new applications without threatening the stability or integrity of the user's personal computer or other device, or the existing system image, until the application has been tried on a copy of the user's system.

The system and method described herein may be adapted to any of a number of IP-enabled devices and not simply the personal computer example described above. An IP-enabled home may include, for example, IP-enabled appliances and controls. If a user is traveling and wants to check or set an IP-accessible thermostat, the controls and data may be mirrored at the SAN and changes to settings may be made by a remote user via the SAN. In like manner, IP enabled video equipment could be backed-up, data accessed and operating systems updated. A traveling user subscribing to the SAN services has the opportunity to obtain access to, and execute, applications such as email, word processing programs, games or any of a number of applications without the need to adjust local device settings because all of the user settings may be incorporated in the device or system image at the SAN 208. Also, bandwidth limitations on a local loop between a user's premises or other user device location, and the central office serving that premise or device location, may be eliminated by permitting a remotely located user (i.e. one that is trying to access his computer or other device from a foreign device) to access the system image at the SAN 208 rather than linking directly to his home/business computer or other device.

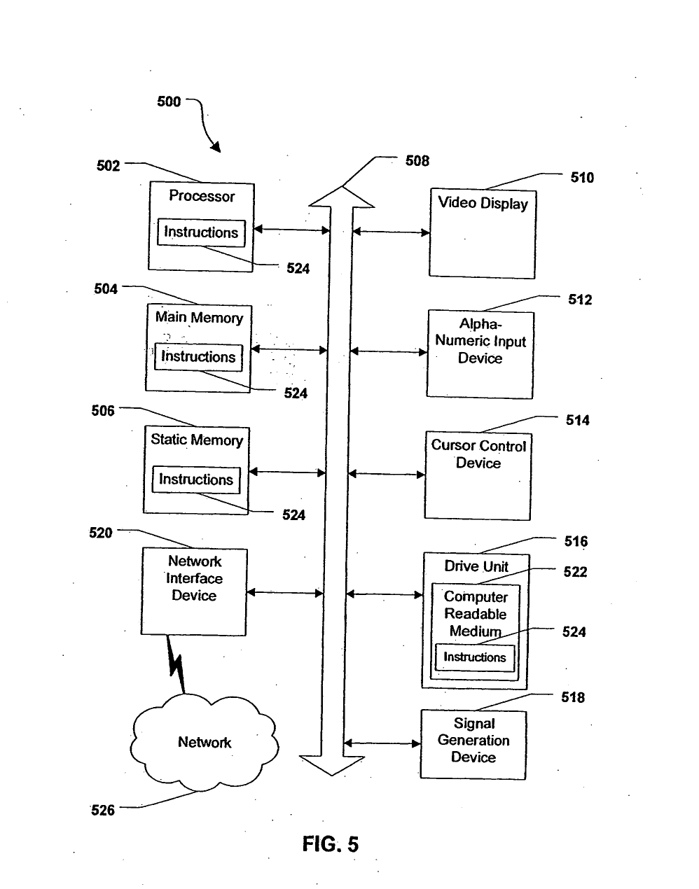

Now referring to FIG. 5, an illustrative embodiment of a general computer system that may be implemented at the user 104, SAN 208, ISP 102 or other portion of the disclosed systems is shown and is designated 500. The computer system 500 can include a set of instructions that can be executed to cause the computer system 500 to perform any one or more of the methods or computer-based functions disclosed herein. The computer system 500 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. Moreover, the computer system 500 can include a main memory 504 and a static memory 506 that can communicate with each other via a bus 508. As shown, the computer system 500 may further include a video display unit 510, such as a liquid crystal display (LCD), an organic light emitting diode (OLED), a flat panel display, a solid state display, or a cathode ray tube (CRT). Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate voice, video or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TR069, TCP/IP, UDP/IP, HTML, and HTTP) represent examples of the state of the art. Such standards are periodically superseded by faster or more efficient equivalents having enhanced or additional functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

With the proposed networking system, subscribed services may provide services for full or incremental ‘backups’ (including incremental and full multiple image rollback capability) and file upgrade, installation, and management services (e.g., upgrades and installation of new software, virus scanning/cleaning of the user's files, among others) while the image(s) are in network storage.

The subscribed services would be supported by a number of different DSL network architectures that can support Internet Protocol (IP). The proposed system infrastructure generally would use the centralized SAN with either high speed Internet Fiber Channel Protocol (IFCP) or Internet Small Computer System Interface (ISCSI) protocol. Also, a subscriber awareness function, such as that available through a customer premise gateway compliant with TR069, may be used to coordinate interaction with IP-enabled devices at the customer premise.

It is therefore intended that the foregoing detailed description be regarded as illustrative rather than limiting, and that it be understood that it is the following claims, including all equivalents, that are intended to define the spirit and scope this invention.

1. A method of providing virtual access services to computing devices connected to an offsite data storage service via communication links, the method comprising:
establishing a first communication link between a first computing device and a service provider providing the offsite data storage service;
accessing data located at the first computing device over the first communication link, and copying a complete system image of the first computing device at the offsite data storage service;
establishing a second communication link between a second computing device and the service provider; and
transmitting at least a portion of the complete system image stored in the offsite data storage service to the second computing device via the second communication link.

2. The method of claim 1, further comprising automatically periodically backing up data from the first computing device to the offsite data storage service to generate an updated complete system image of the first computing device at the offsite data storage service.

3. The method of claim 2, wherein the periodic data back up is performed during idle periods of the first computing device.

4. The method of claim 1, wherein the first communication link is established by the first computing device via a digital subscriber line connection.

5. The method of claim 1, wherein the first communication link is established automatically without user interaction.

6. The method of claim 1, wherein the second communication link is established via an access authorization procedure.

7. The method of claim 6, wherein the access authorization procedure comprises utilization of at least one of a login/user name and password, an IP address, or a pass code.

8. The method of claim 1, further comprising:
selecting, via the offsite data storage service, a part of the accessed data for back up based on activities of the first computing device; and
storing the selected part of the accessed data at the offsite data storage service.

9. The method of claim 1, wherein the first communication link comprises an Internet Fiber Channel Protocol (IFCP) or Internet Small Computer System Interface (ISCSI) protocol.

10. The method of claim 1, wherein the first and second communication links comprise TCP/IP protocol.

11. The method of claim 1, further comprising scanning the accessed data stored at the offsite data storage service for computer viruses.

12. The method of claim 1, further comprising the service provider scanning the first computing device for computer viruses.

13. The method of claim 12, wherein the scanning is performed when computing activities at the first computing device are below a predetermined activity threshold.

14. The method of claim 1, further comprising:
updating software or data in the complete system image at the offsite data storage service and subsequently updating software or data at the first computing device from the offsite data storage service.

15. The method of claim 1, further comprising:
monitoring a status of the first communication link from the offsite data storage service.

16. The method of claim 15, further comprising:
performing diagnostic tests of the first communication link from the offsite data storage service.

17. The method of claim 1, further comprising cleaning viruses from the complete system image of the first computing device at the offsite data storage service.

18. The method of claim 1, wherein the step of data accessing by the second computing device further comprises controlling files associated with the first computing device via the offsite data storage service.

19. An online data storage system accessible to a user for providing virtual access to a computing device, the system comprising:
a data storage unit comprising a complete system image of a first computing device remotely located from the data storage unit;
a communication module configured to automatically and periodically establish communication between the data storage unit and the first computing device; and
a processor configured to automatically update software or data contained in the complete system image and to subsequently update the first computing device from the complete system image.

20. The system of claim 19, wherein the processor is configured to generate an updated system image from the complete system image and wherein the communication module is configured to transmit the updated system image to the first computing device.

21. A computer readable medium comprising computer executable instructions to implement a method for providing virtual access to a computing device of a user comprising:
establishing a first communication link between a first computing device and a service provider providing the offsite data storage service;
accessing data located at the first computing device over the first communication link, and storing a complete system image of the first computing device at the offsite data storage service;
establishing a second communication link between a second computing device and the service provider; and
transmitting at least a portion of the complete system image stored in the offsite data storage service to the second computing device via the second communication link.

22. A computer readable medium comprising computer readable program code embodied therein for providing virtual access to remotely located computing devices, the computer readable program code comprising:
first computer readable program code for causing a computer to establish a first communication link between a first computing device and a service provider configured to provide offsite data storage service;
second computer readable program code for causing a computer to access all data located on the first computing device over the first communication link, and store a complete system image of the first computing device at the offsite data storage service;
third computer readable program code for establishing a second communication link between a second computing device and the service provider; and
fourth computer readable program code for providing the second computing device access to at least part of the complete system image stored in the offsite data storage service via the second communication link.

23. The computer readable medium of claim 22, further comprising:
fifth computer readable program code for initiating back up of data from the first computing device to the offsite data storage service when the first computing device is not in use.

24. The computer readable medium of claim 23, further comprising:
sixth computer readable program code for implementing a virus scan of the first computing device from the service provider.

25. The computer readable medium of claim 22, further comprising fifth computer readable program code for automatically executing a function on the complete system image, generating an updated complete system image based on results of the executed function and providing the updated complete system image to the first computing device upon determination of an availability of the first computing device.
